(19) United States
(12) Patent Application Publication
(10) Pub. No.: US 2021/0031246 A1
(43) Pub. Date: Feb. 4, 2021

(54) METHOD AND DEVICE FOR PREPARING CLEANED ROCK SALT

(71) Applicant: ANTHELA FOODS INC., Kent, WA (US)

(72) Inventors: Shun BAI, Kent, WA (US); Yongliang LIU, Kent, WA (US)

(21) Appl. No.: 17/074,260

(22) Filed: Oct. 19, 2020

Related U.S. Application Data
(63) Continuation-in-part of application No. 15/673,026, filed on Aug. 9, 2017.
Application No. 15/673,026 is a continuation of application No. PCT/CN2016/094353, filed on Aug. 10, 2016.

(51) Int. Cl. B08B 7/04; B08B 13/00; B08B 3/02; B08B 7/02; G06T 7/00; G06T 7/62

(52) U.S. Cl. CPC B08B 7/04; B08B 13/00; B08B 3/022; G06T 2207/30108; G06T 7/0004; G06T 7/62; G06T 2200/04; B08B 7/028

(57) ABSTRACT

A method and a device for preparing cleaned rock salt are provided in the present disclosure. The method includes examining a plurality of rock salt blocks and positioning a qualified rock salt block; performing a first three-dimensional photographing to determine an area of a contaminant; in response to the area of the contaminant, performing a pre-cleaning process, an enhanced cleaning process, and an ultrasonic cleaning process with movable probes or performing a pre-cleaning process; performing an ultrasonic combined cleaning process; monitoring a turbidity level; in response to the turbidity level being monitored, triggering a monitoring alarm or performing a spray cleaning process, an air knife water removal process, and a hot-air drying process on a corresponding rock salt block; after the drying process, performing a second three-dimensional photographing to determine the area of the contaminant; and storing the corresponding rock salt block or performing an online explosive residue detection.

### CROSS-REFERENCE TO RELATED APPLICATIONS

This application is a continuation-in-part (CIP) application of U.S. patent application Ser. No. 15/673,026, filed on Aug. 9, 2017, which is a continuation of International Patent Application No. PCT/CN2016/094353, filed on Aug. 10, 2016, the entire contents of all of which are hereby incorporated by reference.

### FIELD OF THE DISCLOSURE

The present disclosure generally relates to the technical field of rock salt cleaning and, more particularly, relates to a method and a device for preparing cleaned rock salt.

### BACKGROUND

Currently, without using the complicated production process for current refined table salt, Himalayan natural rock salt ores may be prepared into edible salt for human consumption with a simple physical process. Himalayan natural rock salt, considered to be the purest salt, is sold in supermarkets as natural high-end table salt. Such natural rock salt ores are not polluted before mining. However, in the process of mining, storage, transportation, and processing, explosives, oil, soil or other contaminants may remain in the irregular surfaces of the salt ores and the cracks formed by mining. Normally, the surface contaminants of rock salt ores may not be cleaned by most rock salt processing plants. A few manufacturers may apply ordinary cleaning methods for cleaning. However, only soil or dust with weak surface adhesion may be removed, and the contaminants such as explosives and oil stains with high adhesion strength or contaminants in cracks formed because of explosion and mechanical reasons may not be effectively removed. Furthermore, the use of ordinary water sources to clean salt ores may form high-concentration salt-water, and the direct discharge of such high-concentration salt-water may greatly pollute the environment and waste resources. Meanwhile, if ordinary water sources fail to meet drinking water standard, it may cause secondary pollution to the final processed salt. Therefore, it is essential to develop a solution for continuously preparing cleaned rock salt with high efficiency, high safety standard, easy operation, and low energy consumption.

### BRIEF SUMMARY OF THE DISCLOSURE

One aspect of the present disclosure provides a method for preparing cleaned rock salt. The method includes examining a plurality of rock salt blocks to provide a qualified rock salt block for cleaning and positioning the qualified rock salt block; performing a first three-dimensional photographing to determine an area of a contaminant on the qualified rock salt block; in response to the area of the contaminant is equal to or greater than a first contamination area threshold, performing a pre-cleaning process, an enhanced cleaning process, and an ultrasonic cleaning process with movable probes; and in response to the area of the contaminant is less than the first contamination area threshold, performing a pre-cleaning process; performing an ultrasonic combined cleaning process; monitoring a turbidity level in an ultrasonic cleaning tank; in response to an abnormal turbidity level being monitored, triggering a monitoring alarm; and in response to a normal turbidity level being monitored, performing a spray cleaning process, an air knife water removal process, and a hot-air drying process on a corresponding rock salt block; after the drying process, performing a second three-dimensional photographing to determine the area of the contaminant on the corresponding rock salt block; and in response to the area of the contaminant is less than a second contamination area threshold, storing the corresponding rock salt block; and in response to the area of the contaminant is equal to or greater than the second contamination area threshold, performing an online explosive residue detection to determine whether an explosive residue is on the corresponding rock salt block.

Another aspect of the present disclosure provides a device for preparing cleaned rock salt. The device includes an examining and positioning station, configured to examine a plurality of rock salt blocks to provide a qualified rock salt block for cleaning, position the qualified rock salt block, and perform a first three-dimensional photographing to determine an area of a contaminant on the qualified rock salt block; a pre-cleaning station, configured to pre-clean the qualified rock salt block; an ultrasonic cleaning station, configured to ultrasonically clean the qualified rock salt block; an explosive residue detection station, configured to monitor a turbidity level; an air knife water removal station and a hot-air drying station, configured to remove moisture of a corresponding rock salt block; and an examining and unloading station, configured to perform a second three-dimensional photographing to determine the area of the contaminant and store the corresponding rock salt block.

Other aspects of the present disclosure can be understood by those skilled in the art in light of the description, the claims, and the drawings of the present disclosure.

### BRIEF DESCRIPTION OF THE DRAWINGS

Other features, goals, and advantages of the present disclosure will become more apparent via a reading of detailed descriptions of non-limiting embodiments with reference to the accompanying drawings.

FIG. 1 illustrates a flowchart of an exemplary method for preparing cleaned rock salt according to various embodiments of the present disclosure;

FIG. 2 illustrates a front view of an exemplary device for preparing cleaned rock salt according to various embodiments of the present disclosure;

FIG. 3 illustrates a top view of an exemplary device for preparing cleaned rock salt according to various embodiments of the present disclosure;

FIG. 4 illustrates a schematic of an exemplary three-dimensional photographing module in an exemplary device for preparing cleaned rock salt according to various embodiments of the present disclosure;

FIG. 5 illustrates a schematic of a recycling module in an exemplary device for preparing cleaned rock salt according to various embodiments of the present disclosure;

FIG. 6 illustrates a schematic of an air exhausting module in an exemplary device for preparing cleaned rock salt according to various embodiments of the present disclosure;

FIG. 7 illustrates a schematic of a central control system in an exemplary device for preparing cleaned rock salt according to various embodiments of the present disclosure;

FIG. 8 illustrates a schematic of a two-dimensional positioning in an exemplary device for preparing cleaned rock salt according to various embodiments of the present disclosure;

FIG. 9 illustrates a schematic of a spray nozzle layout in an exemplary device for preparing cleaned rock salt according to various embodiments of the present disclosure; and

FIG. 10 illustrates an ultrasonic cleaning schematic of an exemplary device for preparing cleaned rock salt according to various embodiments of the present disclosure.

### DETAILED DESCRIPTION

The foregoing and other objects, features, and advantages of the present disclosure will be more apparent from the following description of embodiments as illustrated in the accompanying drawings. The drawings are not necessarily to scale, emphasis instead being placed upon illustrating principles of the present disclosure.

Specific details are set forth in the following descriptions to provide a full understanding of aspects and embodiments of the present disclosure. The present disclosure may also be implemented through various manners other than those described herein, and similar variations and modifications can be made by those skilled in the art without departing from the spirit and scope of the present disclosure. Therefore, the present disclosure is not limited to specific embodiments disclosed hereinafter.

The present disclosure provides a method for preparing cleaned rock salt, which is described in detail hereinafter according to various embodiments of the present disclosure.

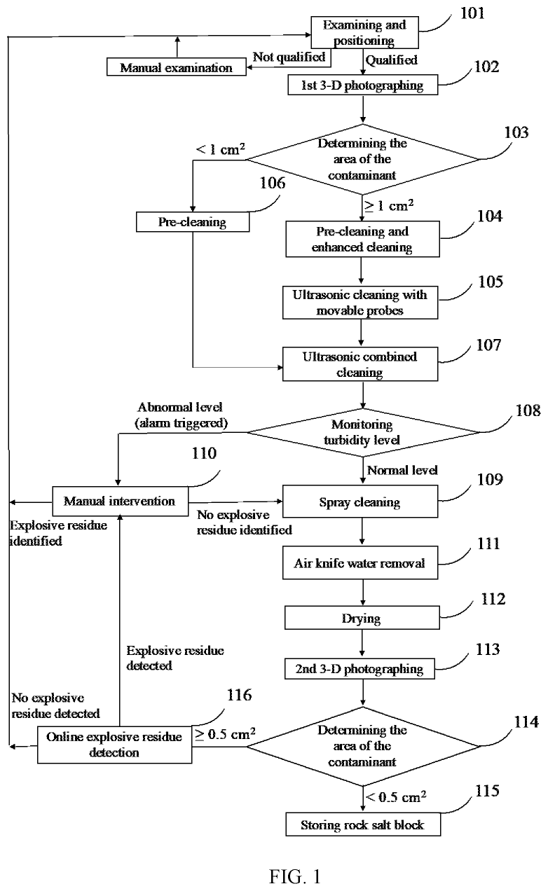

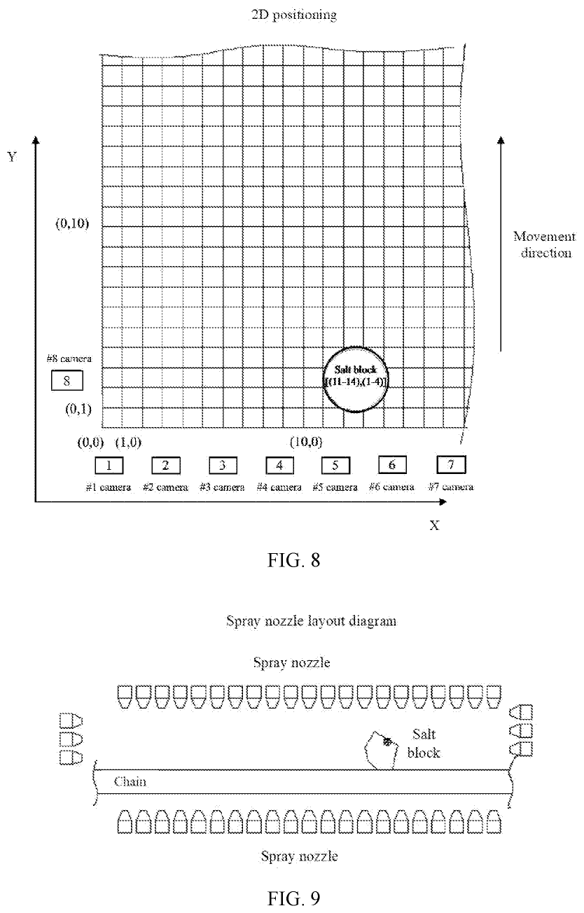

Referring to FIG. 1, in step S101, a plurality of rock salt blocks may be examined to provide qualified rock salt blocks, and the qualified rock salt blocks may be positioned (e.g., two-dimensional positioning in FIG. 8). The examination may be performed on the rock salt blocks for qualification. The short side of the rock salt block may not be less than about 10 cm, and the long side of the rock salt block may not be greater than about 30 cm. The area of the explosive residue, soil, and the like on the rock salt block may be not greater than about 9 cm². No visible explosive residues, oil stains, and soil may be on the contact surface between the rock salt block and a mesh belt, and other locations which may not be limited according to the embodiments of the present disclosure. The slope of the mesh belt may be not greater than about 20 degrees; and the friction between the rock salt block and the mesh belt may ensure that the rock salt block does not change its position by rolling over the mesh belt. The distance between adjacent rock salt blocks may be more than about 30 cm. Optionally, the shape of the rock salt block may be regular or irregular, which may not be limited according to the embodiments of the present disclosure.

In response to a qualified rock salt block, step S102 may be proceeded. In step S102, a first three-dimensional photographing may be performed to determine whether a contaminant is on the qualified rock salt block. An infrared probe may sense the arrival of the rock salt block and then capture three-dimensional images of the rock salt block. A computer system may compute the spatial coordinates of the rock salt block and the contaminant, such as dirt, dust, a stain, an explosive, and/or any other possible substance(s) and determine whether the contaminant is on the qualified rock salt block.

The area of the contaminant may be determined in step S103. In response to the area of the contaminant is equal to or greater than a first contamination area threshold, for example, 1 cm², a combined process with a pre-cleaning process and an enhanced cleaning process (step S104) and an ultrasonic cleaning process using movable probes (step S105) may be performed. In response to the area of the contaminant is less than the first contamination area threshold is less than the first contamination area threshold, the pre-cleaning process (step S106) may be performed.

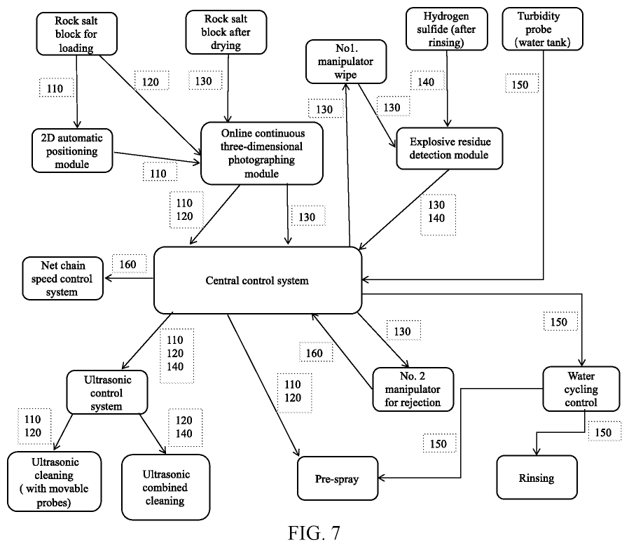

In step S104, referring to FIG. 9, regular-pressure (e.g., 0.1 MPa) spray nozzles and adjustable high-pressure (e.g., 0.3 MPa) spray nozzles may each have 3 groups, which may not be limited according to the embodiments of the present disclosure. The regular pressure spray nozzles may be configured, by a central control system (referring to FIG. 7), to remove the contaminant, including the dust, on the surface of the rock salt block using the regular pressure of 0.1 MPa. The adjustable high-pressure spray nozzles may be configured to align with the three-dimensional position (e.g., spatial coordinates) of the identified contaminant and clean the rock salt block using the high pressure of 0.3 MPa, thereby enhancing the cleaning performance on the rock salt block according to various embodiments of the present disclosure.

In step S105, the ultrasonic cleaning process using movable probes may be performed. For example, the infrared probe may sense the arrival of the rock salt block; and the movable ultrasonic probe may be controlled to align with the three-dimensional position (e.g., spatial coordinates) of the identified contaminant and then clean the identified contaminant on the rock salt block, thereby improving the cleaning efficiency and saving cleaning fluid and energy. Each rock salt group may include 100 rock salt blocks, and the proportion of rock salt blocks cleaned by the ultrasonic probe may be recorded by the central control system.

In step S106, the central control system may use the regular-pressure spray nozzles to remove the contaminant on the surface of the rock salt block.

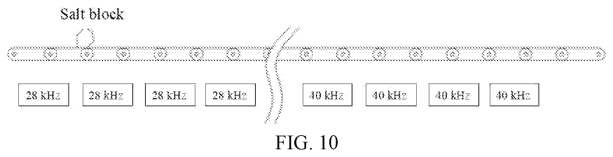

Step S107 may be proceeded after performing S105 or S106. In step S107, an ultrasonic combined cleaning may be performed on the rock salt block. Referring to FIG. 10, an ultrasonic transducer may be sealed in an ultrasonic vibration plate and connected with an ultrasonic generator as a set of the ultrasonic cleaning device. The set quantity of the ultrasonic cleaning devices may be 14 in total, and the ultrasonic frequency may be about 28 kHz or about 40 kHz. 7 sets of the ultrasonic cleaning devices may use about 28 kHz for intensified cleaning, and another 7 sets of the ultrasonic cleaning devices may use about 40 kHz for fine cleaning. 100 rock salt blocks may be organized into one rock salt block group. In one embodiment, when the proportion of rock salt blocks cleaned by the ultrasonic probes is greater than a preset value (e.g., 30% or 40%), the group quantity of the ultrasonic cleaning devices using about 28 kHz may be adjusted, for example, to 10 groups. In addition, when the proportion of rock salt blocks cleaned by the ultrasonic nozzles is greater than 50%, the frequency of 14 sets of the ultrasonic cleaning devices may be automatically changed from about 40 kHz to about 28 kHz.

In step S108, monitoring a turbidity level in an ultrasonic cleaning tank may be performed. The black powder explosive residue on the surface of the rock salt block is mainly potassium sulfide, which can produce hydrogen sulfide when being dissolved in water. A turbidity probe may monitor the concentration of hydrogen sulfide and an alarm may be triggered when the concentration of hydrogen sulfide in the ultrasonic cleaning tank exceeds a preset value (e.g., 0.1 ppm). In response to an abnormal turbidity level, step S110 may be proceeded; in response to a normal turbidity level, steps S109, S111, S112 and S113 may be proceeded.

In step S109, the rock salt block may be cleaned by the spray cleaning process. In step S110, manual intervention may be performed after the monitoring alarm is triggered. That is, whether the explosive residue is on the rock salt block may be manually examined. For example, the device may be shut down, and the reverse osmosis (RO) water purifier may be started to supply water, which may replace the circulation water in the ultrasonic cleaning tank in the cleaning section (e.g., ultrasonic step). Furthermore, whether the rock salt block is clean may be manually examined. If the explosive residue is identified, return to step S101; and if the explosive (residue) is not identified, proceed to step S109.

After performing step S109, steps 111, 112, and 113 may be proceeded. In step S111, the air knife water removal process may be performed to remove water on the surface of the rock salt block. In Step S112, the hot-air convention drying process may be used to further remove water on the surface of the rock salt block. In step 113, a second three-dimensional photographing may be performed. The infrared probe may sense the arrival of the rock salt block and then capture the three-dimensional images of the rock salt block. Two sets of images, which are obtained from steps S102 and S113, respectively, of a same rock salt block may be compared to determine whether the contaminant is still on the same rock salt block.

In step 114, whether the area of the contaminant is less than 0.5 cm² may be determined. In response to the area of the contaminant is less than a second contamination area threshold, for example, 0.5 cm², proceed to step S115 where the rock salt block is stored for future use. In response to the area of the contaminant is equal to or greater than the second contamination area threshold, proceed to step S116.

In step 116, an explosives residue online detection may be performed. A manipulator may be configured, by the central control system, to wipe the contaminant on the salt block with an explosive test paper which is then transported into an explosive detector for testing. If the explosive is detected on the explosive test paper, the manipulator may remove the rock salt block with the contaminant, and step S110 may be proceeded. If the explosive is not detected on the explosive test paper, return to step S101.

The present disclosure provides a device for preparing cleaned rock salt continuously, which is described in detail hereinafter according to various embodiments of the present disclosure.

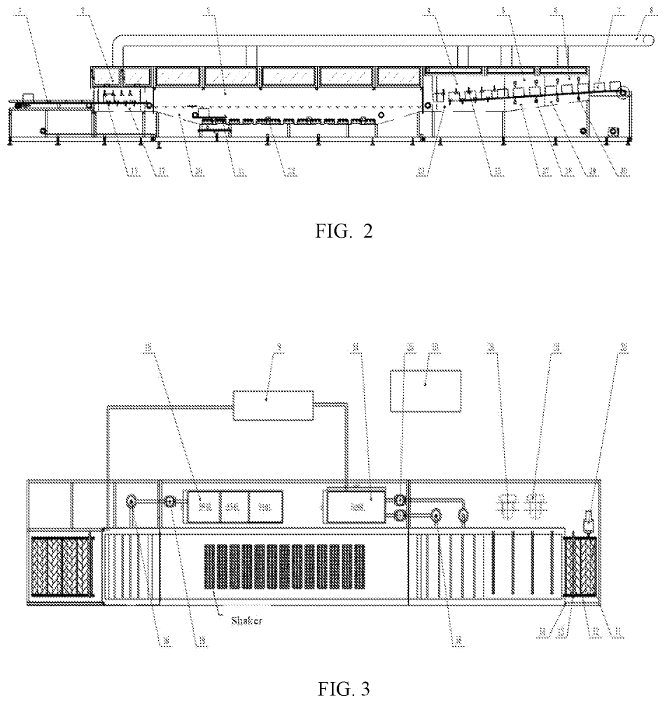

Referring to FIGS. 2-3, FIG. 2 illustrates a front view of an exemplary device for preparing cleaned rock salt according to various embodiments of the present disclosure; and FIG. 3 illustrates a top view of the exemplary device for preparing cleaned rock salt according to various embodiments of the present disclosure.

As shown in FIGS. 2-3, the device for preparing cleaned rock salt may include a examining and loading station 1, a pre-cleaning station 2, an ultrasonic cleaning station 3, a spray cleaning station 4, an air knife water removal station 5, and a hot-air drying station 6, which are connected to a machine frame sequentially by a mesh belt and a chain. The device may further include one or more fast and continuous three-dimensional photographing modules 13, an online explosive residue detection module, an automatic water circulation and treatment module, an air exhausting module 8, a recycling module 9, and an automatic control module 10. The ultrasonic cleaning station 3 may include an ultrasonic cleaning station using movable ultrasonic probes and an ultrasonic combined cleaning station.

The device may further include an examining and unloading station 7. One or more three-dimensional photographing modules 13 may be disposed at each of the examining and loading station 1 and the examining and unloading station 7. Optionally, the device for preparing cleaned rock salt may further include a mesh belt 11, a chain 12, a rack 14, and a driving motor 32.

The examining and loading station 1 may include an automatic two-dimensional positioning module for the rock salt blocks (refer to FIG. 8). For example, during a manual loading process, the plurality of rock salt blocks may be first visually examined to remove obviously unqualified rock salt blocks by controlling the sizes and qualities of the rock salt blocks; and then the rock salt blocks may be arranged on the mesh belt and the planar two-dimensional automatic positioning module on the mesh belt may calculate planar two-dimensional coordinates of the rock salt blocks; and when the rock salt blocks pass through the three-dimensional photographing module, the three-dimensional spatial position and area of a contaminant may be identified, which may provide the basis of the subsequent automatic cleaning processes.

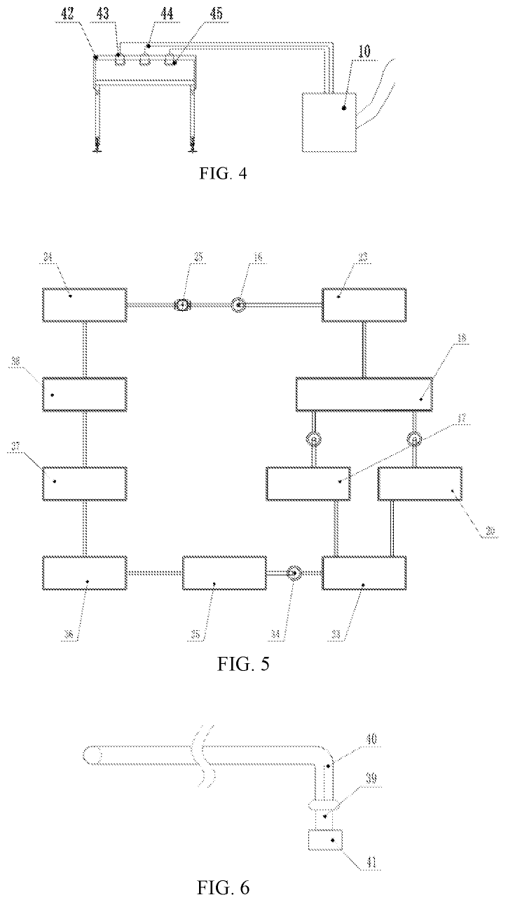

The loading process may be a manual process or an automatic process. Furthermore, the examining and loading station 1 may include the three-dimensional photographing module 13. FIG. 4 illustrates a schematic of an exemplary three-dimensional photographing module in the exemplary device for preparing cleaned rock salt according to various embodiments of the present disclosure.

As shown in FIG. 4, the three-dimensional photographing module 13 may include a support 42, an imaging unit 43, a transmission unit 44, and a protecting unit 45. In one embodiment, the imaging unit 43 may include a plurality of cameras. In another embodiment, the imaging unit 43 may include a plurality of video recorders. Hereinafter, the imaging unit 43 is assumed to include a plurality of cameras for illustrative purposes. Furthermore, the transmission unit 44 may include a plurality of transmission lines, and the protecting unit 45 may include a plurality of protecting covers.

More specifically, the imaging unit 43 may be mounted onto the support 42. Each camera included in the imaging unit 43 may be connected to the automatic control module 10 via a transmission line. Furthermore, each camera may be covered by a protecting cover, and the protecting cover may provide a protection function. Optionally, the support 42 of the three-dimensional photographing module 13 included in the examining and loading station 1 may be integrally connected to a holder of the examining and loading station 1, for example, via a welding process, to form a rigid frame.

In the examining and loading station 1, the three-dimensional photographing module 13 may be configured to collect image information of rock salt blocks. More specifically, the image information of the rock salt blocks collected by the imaging unit 43 in the three-dimensional photographing module 13 may be transmitted to the automatic control module 10 via the transmission unit 44.

Optionally, the examining and loading station 1 may be connected to the rack 14 via the mesh belt 11. The chain 12 may be configured to transport the rock salt blocks from the examining and loading station 1 to the examining and unloading station 7 driven by the driving motor 32.

FIG. 5 illustrates an exemplary schematic view of the recycling module 9 in the exemplary device for preparing cleaned rock salt according to various embodiments of the present disclosure.

The recycling module 9 may include a to-be-processed water tank 33, a water pump 34, a quartz sand filtering unit 35, an activated carbon filtering unit 36, a UV sterilization device 37, and a security filtering unit 38. The water pump 34 may be disposed adjacent to the to-be-processed tank 33. Furthermore, the recycling module 9 may include a high-pressure spraying and rinsing storage tank 24, a high-pressure water pump 25, a filtering unit 16, a high-pressure spraying and rinsing tank 23, a high-pressure spraying and pre-cleaning fluid storage tank 18, a spraying and pre-cleaning tank 17, and an ultrasonic cleaning tank 20. As described above, the filtering unit 16 and the high-pressure spraying and rinsing tank 23 may together form the cleaning station 4.

More specifically, in the recycling module 9, the cleaning station 4 may extract the cleaning fluid from the high-pressure spraying and rinsing storage tank 24 to spray and rinse the rock salt blocks. The rinsed cleaning fluid may then enter the high-pressure spraying and pre-cleaning storage tank 18 after flowing through the high-pressure spraying and rinsing tank 23. The cleaning fluid in the high-pressure spraying and pre-cleaning storage tank 18 may be configured to pre-clean and perform ultrasonic cleaning on the rock salt blocks.

Furthermore, the cleaning fluid in the high-pressure spraying and pre-cleaning storage tank 18 may later flow through the spraying and pre-cleaning tank 17 and the ultrasonic cleaning tank 20, respectively, to enter the to-be-processed tank 33. The cleaning fluid in the to-be-processed tank 33 may then sequentially pass through the quartz sand filtering unit 35, the activated carbon filtering unit 36, the UV sterilization device 37, and the security filtering unit 38 to return back to the high-pressure spraying and rinsing storage tank 24.

Accordingly, in the recycling device, fresh cleaning fluid may only need to be supplied to the high-pressure spraying and rinsing storage tank 24 regularly. Furthermore, solid substances filtered out by the quartz sand filtering unit 35, the activated carbon filtering unit 36, and the security filtering unit 38 may be processed timely, thereby achieving a safe, environmentally friendly, and power-efficient effect.

FIG. 6 illustrates a schematic of the air exhausting module 8 in the exemplary device for preparing cleaned rock salt according to various embodiments of the present disclosure. The air exhausting module 8 may include exhaust fans, exhaust ducts, and condensers. One end of the exhaust pipe may be respectively connected with the above-mentioned stations, and the other end may be connected with the exhaust fans, and the exhaust fans may be connected with the condensers. The exhaust fans may draw out the water mist and cold air generated in each station section through the exhaust pipe, and recondense the water mist and cold air into water through the condenser and return to the high-pressure spray rinsing tank.

Referring to FIG. 6, the air exhausting module 8 may include an air-exhausting fan 39, an air-exhausting pipe 40, and a condensing unit 41.

Furthermore, the examining and unloading station 7 may include the three-dimensional photographing module 13. In one embodiment, the three-dimensional photographing module 13 in the examining and unloading station 7 may be the same as the three-dimensional photographing module 13 in the examining and loading station 1. For example, the support 42 of the three-dimensional photographing module 13 included in the examining and unloading station 7 may be integrally connected to a holder of the examining and unloading station 7 (e.g., via a welding process) to form a rigid frame. Moreover, the three-dimensional photographing module 13 in the examining and unloading station 7 may be configured to collect the image information of the rock salt blocks, and the image information may be transmitted to the automatic control module 10 via the transmission line 44.

FIG. 7 illustrates a schematic of a central control system in the exemplary device for preparing cleaned rock salt according to various embodiments of the present disclosure. For example, at 110, after loading and positioning the rock salt block, the rock salt block may be transported to the three-dimensional photographing module; and after the three-dimensional photographing module captures the images, the captures images may be transmitted to the central control system to control the operation of the ultrasonic cleaning process and the pre-cleaning process; at 120, after loading the rock salt block, the rock salt block may be transported to the three-dimensional photographing module; and after the three-dimensional photographing module captures the images, the captures images may be transmitted to the central control system to control the operation of the ultrasonic cleaning process and the pre-cleaning process; at 130, after the dried rock salt block is determined by the three-dimensional photographing module, and the signal is transmitted to the central control system; and the central control system may control the first manipulator to wipe the rock salt block to determine whether the explosive is on the rock salt block, and control the second manipulator to remove the explosive; at 140, a hydrogen sulfide probe may collect the data of the hydrogen sulfide in air which may be transmitted to the explosive residue detection module and then transmitted to the central control system, thereby controlling the intensity of the ultrasonic combined cleaning process; at 150, a turbidity probe may detect the turbidity in a water tank, the central control system may control the water circulation and adjust the pre-cleaning process and the spray cleaning process according to the turbidity; at 160, the second manipulator may transmit the data of the removed rock salt blocks to the central control system which may adjust the speed of the chain.

In one embodiment, referring to FIG. 8, a matrix, with a planar two-dimensional coordinate unit of one square centimeter, may be disposed on the mesh belt that is loaded with the rock salt blocks; when the rock salt blocks on the mesh belt pass through a photographic three-dimensional scanner, the three-dimensional coordinates (e.g., X,Y,Z) of each rock salt block may be calculated from the three-dimensional imaging data by the automatic control system. Based on the three-dimensional coordinates, the spatial position and the area of contaminant may be determined for providing the basis of the subsequent processes, for example, including the ultrasonic cleaning process and the explosive residue detection process. The mesh belt structure may be configured to ensure that the loaded rock salt blocks may not move during continuous chain operation and the cleaning processes.

The three-dimensional photographing modules 13 may be installed at the loading side and the unloading side of the device for preparing cleaned rock salt and may include the plurality of high-resolution photographic scanners along the X, Y and Z directions.

When each rock salt block passes through the device for preparing cleaned rock salt blocks, three-dimensional images may be quickly captured and formed after the image data is processed by the computer system. The above-mentioned images may be compared with the contaminant template previously stored in the computer system to identify the coordinates and area of the contaminant. The contaminants formed on the surface of rock salt blocks such as explosives, soil, and oil taints, may be photographed and manually identified, and then may be entered into the computer for AI data leaning to form the contaminant template. The contaminants may be determined according to the color differences between the contaminants and rock salt blocks (e.g., the contaminants may be black, brown, or other dark colors) and the light transmittance difference (e.g., the contaminant may have no transmittance or low transmittance). For example, the regions with white and pink colors may not be determined as contaminants, and the regions with other colors may be determined as contaminants. When photographing the rock salt blocks at the loading side, the objective may mainly be determining the position and area of the contaminant. While, when photographing the rock salt blocks at the unloading side, the objective may mainly be determining whether the contaminant is removed after the cleaning processes are completed by comparing the images before and after the cleaning processes.

The core of the salt block automatic positioning module and the online continuous three-dimensional photographing module 13 may be the computer intelligent module for automatic identification of contaminants and automatic cleaning control system (e.g., the spray cleaning process, the ultrasonic positioning cleaning process, and the ultrasonic combined cleaning process.

Referring to FIG. 2 and FIG. 9, the high-pressure pre-cleaning station 2 may include a plurality of nozzles, a plurality of filters, a spraying and pre-cleaning tank, and a spraying and pre-cleaning storage tank. A plurality of frequency-conversion control water pumps may be installed adjacent to the spraying and pre-cleaning storage tank. The nozzles may be arranged on the upper and lower sides of the mesh belt along the moving direction of the mesh belt. The rock salt blocks loaded on the mesh belt may pass through the nozzles. The frequency-conversion control water pumps may be connected to the filters; the filters may be connected to the nozzles; and the frequency-conversion control water pumps may be connected to the automatic control system, thereby controlling the quantity and pressure of water. After the contaminants are identified by the computer system and when the rock salt blocks with contaminants pass through the pre-cleaning station 2, the nozzles and the water pumps may be adjusted to align the nozzles with the contaminated areas with high-intensity cleaning, thereby improving the performance of the cleaning device according the embodiments of the present disclosure.

The pre-cleaning station 2 may be configured to pre-clean the rock salt blocks transferred from the examining and loading station 1. That is, after being processed by the examining and loading station 1, the rock salt blocks may enter the pre-cleaning station 2. More specifically, the pre-cleaning station 2 may include a plurality of spray nozzles 15, a filtering unit 16, a spraying and pre-cleaning tank 17, a high-pressure spraying and pre-cleaning storage tank 18, and a frequency-conversion control water pump 19.

The pre-cleaning station 2 may be configured to extract a cleaning fluid from the high-pressure spraying and pre-cleaning storage tank 18 via the frequency-conversion control water pump 19. The frequency-conversion control water pump 19 may be coupled to the plurality of nozzles 15 that spray the extracted cleaning fluid to adjust the spraying speed of the cleaning fluid. The sprayed cleaning fluid may flow in the spraying and pre-cleaning tank 17.

Furthermore, the frequency-conversion control water pump 19 may be connected to the automatic control module 10. Under control of the automatic control module 10, the frequency-conversion control water pump 19 included in the pre-cleaning module 2 may change the inlet and outlet flow, and the pressure and cleaning time of each nozzle 15 may be adjusted.

For the automatic control module 10, after the spatial position and area of the contaminant are identified by the computer system and also after the rock salt blocks pass through the above-mentioned automatic high-intensity cleaning processes, the manipulator may be automatically aligned the movable ultrasonic probes to the contaminated area with high-intensity cleaning. The self-aligned mechanical ultrasonic vibration may enable the water flow to form unique ultrasonic bubbles. The high-intensity ultrasonic energy released at the moment of the ultrasonic bubble burst may be used to loosen or peel off the stubborn contaminants attached.

The ultrasonic cleaning station 3 may comprise the ultrasonic cleaning tank 20, an ultrasonic resonator unit 21 including ultrasonic resonators, and a liquid turbidity detection unit 22. The ultrasonic cleaning tank 20 may be configured to hold a cleaning fluid. The ultrasonic resonators may have 14 ultrasonic subsets arranged sequentially and may be disposed equidistantly along the moving direction of the mesh belt. The frequencies of the ultrasonic resonators may be automatically switched between about 28 kHz and about 40 kHz (refer to FIG. 10).

After the rock salt blocks are loaded on the mesh belt, the rock salt blocks may pass over the ultrasonic resonators. After the contaminants are detected by the computer system, the rock salt blocks may enter the ultrasonic combined cleaning process for deep cleaning after the high-intensity enhanced cleaning process and the ultrasonic cleaning with movable probes. When the rock salt blocks with identified contaminants pass through the ultrasonic cleaning station 3, the frequency of the ultrasonic resonators may be automatically adjusted to 28 kHz for high-intensity cleaning according to the areas of the contaminants. The frequency of the ultrasonic resonators may be maintained at normal intensity of 40 kHz when the rock salt blocks without identified contaminants pass through such region. Frequency-conversion control water pumps may also be disposed adjacent to the ultrasonic cleaning tank 20. The frequency-conversion control water pumps may be connected to the ultrasonic cleaning tank 20 to supply water to the ultrasonic cleaning tank 20 and may also be connected to the automatic control module to control the water flows of the pumps. The ultrasonic cleaning tank 20 may be equipped with a drain outlet, an overflow outlet, and a sewage outlet. The liquid turbidity detection module may be connected with the automatic control module to detect the liquid turbidity.

Furthermore, the ultrasonic resonator unit 21 and the liquid turbidity detection unit 22 may be disposed inside the ultrasonic cleaning tank 20. For example, the ultrasonic resonator unit 21 and the liquid turbidity detection unit 22 may be disposed in the middle portion of the ultrasonic cleaning tank 20. Optionally, the ultrasonic resonator unit 21 may not contact the rock salt blocks directly. For example, the ultrasonic resonator unit 21 may be placed below the mesh belt 11 while the rock salt blocks are placed on the mesh belts. Furthermore, the ultrasonic resonator unit 21 and the rock salt blocks are immersed in the cleaning fluid, and the rock salt blocks may be cleaned via the cavitation effect of the ultrasonic waves generated by the ultrasonic resonator unit 21.

Moreover, the ultrasonic resonator unit 21 and the liquid turbidity detection unit 22 may be connected to the automatic control module 10, respectively. The ultrasonic resonator unit 21 may be configured to detect the frequency of the ultrasonic resonator. The liquid turbidity detection unit 22 may be configured to detect the liquid turbidity of the cleaning fluid in the ultrasonic cleaning tank 20. The detected information such as the frequency of the ultrasonic resonator and the liquid turbidity of the cleaning fluid may be transmitted to the automatic control module 10.

Based on the detected frequency of the ultrasonic resonator fed back to the automatic control module 10, the automatic control module 10 may control and adjust the frequency of the resonator. Further, based on the liquid turbidity of the cleaning fluid fed back to the automatic control module 10, the automatic control module 10 may be configured to control whether the ultrasonic cleaning tank 20 changes the cleaning fluid or not.

Optionally, the ultrasonic resonator unit 21 may include a plurality of ultrasonic resonators. The plurality of ultrasonic resonators may resonate on the flat bottom of the middle portion of the ultrasonic cleaning tank 20. Or, optionally, the plurality of ultrasonic resonators may be placed and resonate in a plurality of holders fixedly attached on the bottom of the ultrasonic cleaning tank 20. Further, the number of ultrasonic resonators disposed in each holder may be the same or different, and the plurality of ultrasonic resonators, together with the plurality of holders, may be configured to generate ultrasonic waves.

For example, as shown in FIG. 2 and FIG. 10, the plurality of ultrasonic resonators may be placed in holders (e.g., fourteen) fixedly attached at the same intervals on the bottom of the ultrasonic cleaning tank 20. Each of the holders (e.g., fourteen) may include three rows of resonators, and each row of resonators may include a plurality of resonators.

Optionally, the ultrasonic cleaning station 3 may include a plurality of liquid turbidity detection units 22. For example, as shown in FIG. 2, four liquid turbidity detection units 22 may be disposed in the middle portion of the ultrasonic cleaning tank 20.

Optionally, the cleaning fluid in the ultrasonic cleaning tank 20 may be saturated salt-water (e.g., NaCl). The saturated salt-water may be chosen as the cleaning fluid because of reasons such as being unable to dissolve the effective ingredient of the rock salt blocks, having a relatively large density, a relatively large surface tension, and viscosity higher than pure water. Accordingly, the cavitation threshold of the cavitation effect generated by the cleaning fluid may be relatively large.

Furthermore, the power density of the ultrasonic power may be approximately 16 W/L. Under such power density, the power may be adjusted to vary the strength of the cavitation effect to achieve satisfying cleaning effect.

Moreover, the contamination of the cleaning fluid in the whole cleaning process may be sensed, monitored, and processed. For example, the ultrasonic cleaning station 3 may further include an outlet, an overflow port, and a sewage draining exit. Because the liquid turbidity detection unit(s) 22 may be configured to feed back the detected information (e.g., liquid turbidity) to the automatic control module 10, the automatic control module 10 may change the cleaning fluid in the ultrasonic cleaning station 3.

The high-pressure spray cleaning station 4 may include a high-pressure spray cleaning tank, a high-pressure spray reservation tank, a plurality of nozzles, and a plurality of filters. A high-pressure water pump may be installed adjacent to the high-pressure spray cleaning tank. The nozzles, arranged in multiple groups, may be disposed on the upper and lower sides of the mesh belt along the moving direction of the mesh belt. The rock salt blocks loaded on the mesh belt may pass through the nozzles. High-pressure water pumps may be connected to the filters which are then connected to the nozzles.

For example, the spray cleaning station 4 may include a plurality of spray nozzles 15, and a high-pressure spraying and rinsing tank 23. Under the work condition, the spray cleaning station 4 may extract the cleaning fluid from the high-pressure spraying and rinsing storage tank 24 using the high-pressure water pump 25. Optionally, the spray cleaning station 4 may further include a filtering unit 16 disposed between the high-pressure water pump 25 and the high-pressure spraying and rinsing tank 23. The filtering unit 16 may be configured to filter the cleaning fluid extracted from the high-pressure spraying and rinsing storage tank 24 before the cleaning fluid flows into the high-pressure spraying and rinsing tank 23. The cleaning station 4 may be further configured to spray the cleaning fluid to the rock salt blocks via the plurality of spray nozzles 15. The high-pressure spraying and rinsing tank 23 may be configured to hold and let the sprayed cleaning fluid flow therein.

After going through the ultrasonic cleaning station 3, the rock salt blocks may enter the drying process. The drying process may include the high-pressure air knife water removal station 5 and the hot-air drying station 6. The high-pressure air knife water removal station 5 may include a high-pressure air pump, a water cutting tank, and a plurality of air knives arranged in multiple groups. The high-pressure wind pump may be connected to the air knives. The air knives may be arranged on the upper and lower sides of the mesh belt along the moving direction of the mesh belt. The rock salt blocks loaded on the mesh belt may pass through the upper and lower air knives. More specifically, the high-pressure air knife water removal station 5 may include a high-pressure air pump 26, an air knife 27, and a water-removing tank 28. The high-pressure air knife water removal station 5 may be configured to remove water from surfaces of rock salt blocks by applying a high-pressure air.

For example, after the rock salt blocks pass through the air knife 27 in the high-pressure air knife water removal station 5, most water or moisture on surface of the rock salt blocks may be removed. Optionally, a pair of air knives 27 may be disposed on the upper and lower sides of the high-pressure air knife water removal 5 to remove the water or moisture on surface of the rock salt blocks. More specifically, the pair of air knives 27 may include an upper air knife and a lower air knife. The lower air knife may be disposed below the mesh belt 11 and within a proper distance to the bottom of the rock salt blocks. The upper air knife may be disposed above the mesh belt 11 and within a proper distance to the top of the rock salt blocks. The distance from the lower air knife to the rock salt blocks and the distance from the upper air knife to the rock salt blocks may be adjusted, respectively.

The hot-air drying station 6 may include a drying oven 29, a hot air knife 30, and a hot air pump 31. The hot air pump 31 may be configured to generate a hot wind, and the hot wind generated by the hot air pump 31 may be blown out towards the rock salt blocks via the hot air knife 30. After pass through the high-pressure air knife water-removing unit 5, the rock salt blocks may enter the hot-air drying station 6. Accordingly, the surface temperature of the rock salt blocks may be increased, such that the rock salt blocks may be further dried. Optionally, a pair of hot air knives 30 may be disposed on the upper and lower sides of the hot-air drying station 6.

The device for preparing cleaned rock salt may include the online explosive residue detection module. Two types of explosives, black powder or non-black powder may be used in rock salt mining. Both explosives may leave black explosive residues on the surface of the rock salt. The black powder residue may be mainly potassium sulfide, which can be pre-detected by a gas detection method. Hydrogen sulfide gas may be generated after potassium sulfide is dissolved in water. In the pre-cleaning process, a hydrogen sulfide monitoring detector may be installed to monitor the hydrogen sulfide content in real time, and the data may be fed back to the automatic control module in a timely manner to determine whether the rock salt block in current process contains the explosive (e.g., black powder) over a preset limit (or value). If the alarm of the explosive (e.g., black powder) detector is triggered, the batch of rock salt blocks in the ultrasonic cleaning pool may be manually identified in order. After the rock salt blocks pass the ultrasonic combined cleaning process, the air knife water removal process and the drying process, the images of the rock salt blocks after the cleaning processes may be compared with the images of the rock salt blocks before the cleaning processes. If the contamination (e.g. black) area over the limit is still on the image after the cleaning processes, the online explosive residue detection module may be performed. For example, the manipulator may be configured to wipe the surface of the rock salt block with an explosive test paper which is then transported into an explosive detector (e.g., whether the explosive residue or any explosive present). If the explosive residue is not detected, the rock salt block may pass the test; and if the explosive residue is detected, the rock salt block is determined to be objection which may need manual examination.

From the above-mentioned embodiments, it can be seen that the method and the device for preparing cleaned rock salt provided by the present disclosure may achieve at least the following beneficial effects.

According to various embodiments of the present disclosure, the examining and loading station may be disposed with the three-dimensional photographing module to determine the area of the contaminant, different cleaning processes (paths) may be selected to clean the contaminated rock salt block according to the area of the contaminant, thereby improving the cleaning efficiency and lowering the energy consumption; moreover, the two-dimensional positioning may provide precise coordinates of the rock salt block, which may facilitate subsequent cleaning processes; furthermore, the water pressure and the cleaning duration may also be adjusted according to the contamination degree, thereby achieving a desirable cleaning effect; if the cleanness degree of the rock salt block does not meet the requirements, the frequency of the ultrasonic resonator may be adjusted to enable the ultrasonic cleaning to be more precise, thereby saving energy and improving the cleaning quality; the examining and unloading station may also be disposed with the three-dimensional photographing module, which may implement the cleaning quality control of the rock salt block, thereby obtaining the rock salt block with desirable cleaning quality; in addition, the online explosive residue detection module may be configured to conveniently monitor the explosive residue on the rock salt block, thereby achieving a desirable cleaning effect.

It should be noted that, the above detailed descriptions illustrate only preferred embodiments of the present disclosure and technologies and principles applied herein. Those skilled in the art can understand that the present disclosure is not limited to the specific embodiments described herein, and numerous significant alterations, modifications and alternatives may be devised by those skilled in the art without departing from the scope of the present disclosure.

Thus, although the present disclosure has been illustrated in above-described embodiments in details, the present disclosure is not limited to the above embodiments. Any equivalent or modification thereof, without departing from the spirit and principle of the present invention, falls within the true scope of the present invention, and the scope of the present disclosure is defined by the appended claims.

What is claimed is:

1. A method for preparing cleaned rock salt, comprising:
examining a plurality of rock salt blocks to provide a qualified rock salt block for cleaning, and positioning the qualified rock salt block;
performing a first three-dimensional photographing to determine an area of a contaminant on the qualified rock salt block;
in response to the area of the contaminant is equal to or greater than a first contamination area threshold, performing a pre-cleaning process, an enhanced cleaning process, and an ultrasonic cleaning process with movable probes; and in response to the area of the contaminant is less than the first contamination area threshold, performing the pre-cleaning process;
performing an ultrasonic combined cleaning process;
monitoring a turbidity level in an ultrasonic cleaning tank; in response to an abnormal turbidity level being monitored, triggering a monitoring alarm; and in response to a normal turbidity level being monitored, performing a spray cleaning process, an air knife water removal process, and a hot-air drying process on a corresponding rock salt block;
after the drying process, performing a second three-dimensional photographing to determine the area of the contaminant on the corresponding rock salt block; and
in response to the area of the contaminant is less than a second contamination area threshold, storing the corresponding rock salt block; and in response to the area of the contaminant is equal to or greater than the second contamination area threshold, performing an online explosive residue detection to determine whether an explosive residue is on the corresponding rock salt block.

2. The method according to claim 1, after examining the plurality of rock salt blocks, further including:
performing a manual examination on an unqualified rock salt block.

3. The method according to claim 1, further including:
when the monitoring alarm is triggered, manually examining whether an explosive residue is on a corresponding rock salt block.

4. The method according to claim 3, wherein:
in response to the explosive residue being identified, performing examining and positioning on the corresponding rock salt block; and
in response to the explosive residue not being identified, performing the spray cleaning process, the air knife water removal process, and the drying process on the corresponding rock salt block.

5. The method according to claim 1, wherein performing the online explosive residue detection includes:
in response to the explosive residue being detected, manually examining whether the explosive residue is on the corresponding rock salt block; and
in response to the explosive residue not being detected, performing examining and dimensional positioning on the corresponding rock salt block.

6. The method according to claim 1, wherein:
the first contamination area threshold is about 1 cm².

7. The method according to claim 1, wherein:
the second contamination area threshold is about 0.5 cm².

8. The method according to claim 1, wherein:
the contaminant includes dirt, dust, a stain, an explosive residue, or a combination thereof.

9. The method according to claim 1, wherein:
positioning the qualified rock salt block includes two-dimensional positioning of the qualified rock salt block.

10. The method according to claim 1, wherein:
for monitoring the turbidity level, a concentration of hydrogen sulfide is monitored.

11. A device for preparing cleaned rock salt, comprising:
an examining and positioning station, configured to examine a plurality of rock salt blocks to provide a qualified rock salt block for cleaning, position the qualified rock salt block, and perform a first three-dimensional photographing to determine an area of a contaminant on the qualified rock salt block;
a pre-cleaning station, configured to pre-clean the qualified rock salt block;
an ultrasonic cleaning station, configured to ultrasonically clean the qualified rock salt block;
an explosive residue detection station, configured to monitor a turbidity level;
an air knife water removal station and a hot-air drying station, configured to remove moisture of a corresponding rock salt block; and
an examining and unloading station, configured to perform a second three-dimensional photographing to determine the area of the contaminant and store the corresponding rock salt block.

12. The device according to claim 9, wherein:
the examining and positioning station includes a two-dimensional positioning module configured to calculate planar coordinates of the plurality of rock salt blocks.

13. The device according to claim 9, wherein:
one or more three-dimensional photographing modules are disposed at the examining and positioning station and the examining and unloading station.

14. The device according to claim 9, wherein:
the ultrasonic cleaning station includes an ultrasonic cleaning process with movable probes and an ultrasonic combined cleaning process.

15. The device according to claim 12, wherein:
the ultrasonic cleaning station includes regular-pressure spaying nozzles and adjustable high-press spray nozzles.

16. The device according to claim 13, wherein:
a regular pressure is about 0.1 mPa, and a high pressure is about 0.3 mPa.

17. The device according to claim 9, wherein:
an ultrasonic frequency is about 28 kHz or about 40 kHz.

18. The device according to claim 9, further including:
an online explosive residue detection module, configured to determine whether an explosive residue is on the corresponding rock salt block.

19. The device according to claim 9, wherein:
a first contamination area threshold is about 1 cm², and a second contamination area threshold is about 0.5 cm².

20. The device according to claim 9, wherein:
the contaminant includes dirt, dust, a stain, an explosive residue, or a combination thereof.
